(19) United States
(12) Patent Application Publication
(10) Pub. No.: US 2009/0249483 A1
(43) Pub. Date: Oct. 1, 2009

(54) Command and Control Systems for Cyber Warfare

(75) Inventor: Jonathon P. Leibunguth, Arlington, VA (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/414,126

(22) Filed: Mar. 30, 2009

Related U.S. Application Data
(60) Provisional application No. 61/041,073, filed on Mar. 31, 2008.

(51) Int. Cl. G06F 21/00; G06F 15/173

(52) U.S. Cl. 726/22; 709/224; 718/100

(57) ABSTRACT

According to one embodiment, a method includes receiving data regarding a plurality of first parameters of a network. Each first parameter is mapped to a respective second parameter of a computer-readable cyber battle management language. The computer-readable cyber battle management language is operable to express an operational order in the form of a text-based instruction having a computational grammatical structure. The operational order is to be executed at least partially within the network and is related to cyber warfare. The computer-readable battle management language is also operable to express a situation report related to cyber warfare. The situation report is expressed in terms of one or more of the second parameters. The situation report may describe a change in one or more of the first parameters.

### RELATED APPLICATION

This application claims benefit under 35 U.S.C. § 119(e) of U.S. Provisional Application Ser. No. 61/041,073, entitled “Cyber Battle Management Language” filed Mar. 31, 2008, by Jonathon P. Leibundguth.

### TECHNICAL FIELD

This invention relates generally to the field of information management networks, and more specifically to command and control systems for cyber warfare.

### BACKGROUND

Some command and control decision support systems manage battle scenarios through the exchange of information using natural language. In conventional warfare, for example, various military units may be given operational orders to take up positions, withdraw, withhold firing, engage an enemy, etc. Some operational orders may be strategically responsive to reports that may describe, for example, the progress of a battle, intelligence on enemy tactics or movements, etc.

### SUMMARY OF THE DISCLOSURE

According to one embodiment, a method includes receiving data regarding a plurality of first parameters of a network. Each first parameter is mapped to a respective second parameter of a computer-readable cyber battle management language. The computer-readable cyber battle management language is operable to express an operational order in the form of a text-based instruction having a computational grammatical structure. The operational order is to be executed at least partially within the network and is related to cyber warfare. The computer-readable battle management language is also operable to express a situation report related to cyber warfare. The situation report is expressed in terms of one or more of the second parameters. The situation report may describe a change in one or more of the first parameters.

Certain embodiments may provide one or more technical advantages. A technical advantage of one embodiment may be that data communicated in a variety of proprietary formats may be adapted to a standard used by a particular cyber battle management language. The cyber battle management language may express operational orders and situation reports, as applied to a cyber domain, using a computational grammatical structure that may be unambiguously interpreted by humans and automated systems. Another technical advantage of one embodiment may be that the adaptations of the formats may facilitate the integration of cyber warfare with conventional non-cyber warfare.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram showing one embodiment of a system that may be used to facilitate the command and control of cyber warfare according to the teachings of the present disclosure; and

FIG. 2 shows one embodiment of a method for facilitating the command and control of cyber warfare performed by the system of FIG. 1.

### DETAILED DESCRIPTION OF THE DRAWINGS

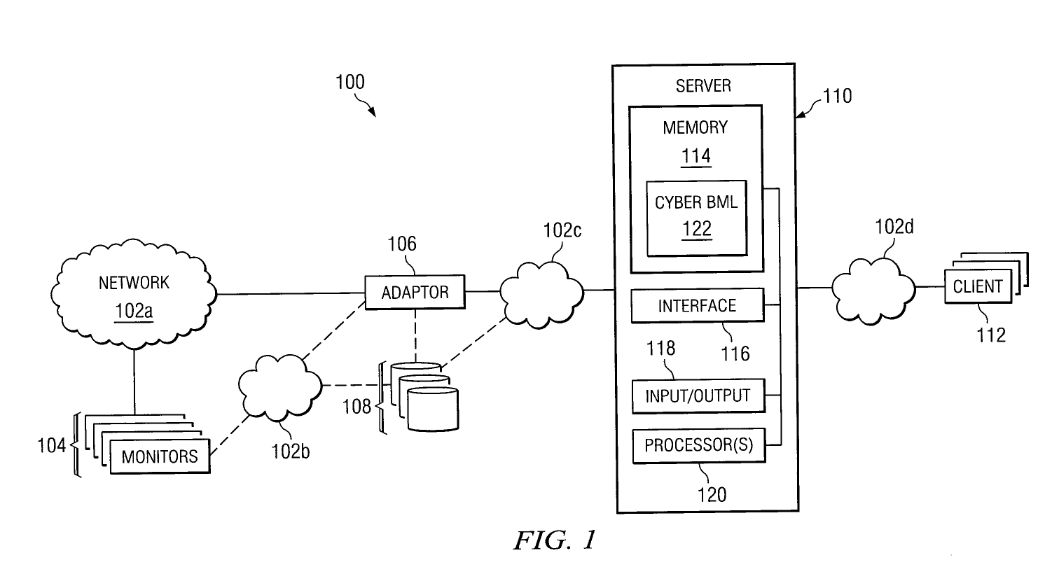

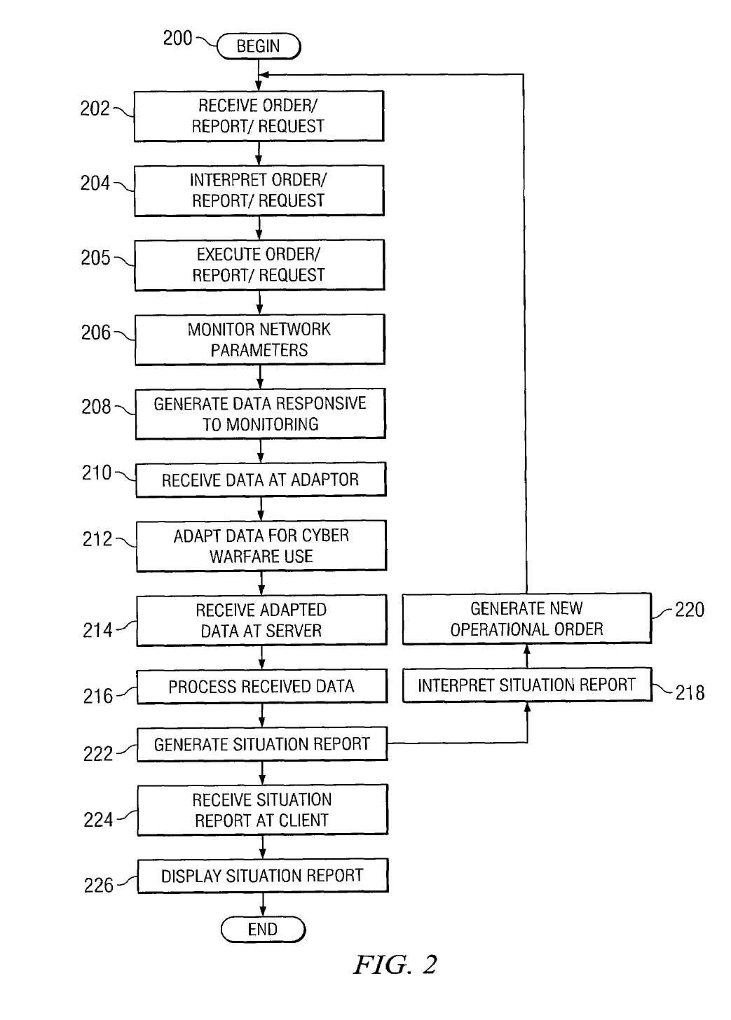

Particular embodiments of the present disclosure may be explained in the context of cyber warfare. The term “cyber warfare” as used herein generally refers to any attacking and/or defensive acts conducted for military advantage at least partially or entirely within a cyber domain. Some cyber domains may be described in terms of electromagnetic communications, network operations, and/or electronics that are at least partially enabled by computing systems and supportive infrastructure. In particular embodiments, a battle management language may enable the expression of information regarding cyber warfare in a manner that may be interpreted and executed by humans and machines. Embodiments of the present invention and its advantages are best understood by referring to FIGS. 1 and 2 of the drawings, like numerals being used for like and corresponding parts of the various drawings.

FIG. 1 is a block diagram illustrating one embodiment of a system 100 that may be used to facilitate the command and control of cyber warfare. In the illustrated embodiment, system 100 generally includes one or more of each of the following: a network 102 (102a-d), a monitor 104, an adaptor 106, data storage 108, a server 110, and a client 112. In this example, system 100 facilitates command and control of cyber warfare at least partially through the use of a cyber battle management language (cyberBML).

The cyberBML used by system 100 is generally capable of expressing, in the context of a cyber domain, attacking and defensive orders, situation reports, queries, and/or query results using a computational grammatical structure that may be substantially unambiguously interpreted by humans and/or machines. In this manner, unambiguous cyberBML communications may be exchanged between military actors and system 100, and/or between the various components of system 100, such that the strategic intent as applied to a cyber domain may be communicated, interpreted, and/or executed by humans and/or machines.

The term “order” as used herein includes, but is not limited to, operations or operational orders, deployment orders, execution orders, warning orders, or any of a variety of other orders that may be executed at least partially within a cyber domain in the context of cyber warfare. Some orders and/or information requests may or may not be interpreted as compulsory, however in this example orders generally command the performance of tasks and information requests generally request particular queries. The terms “information request” or “query” as used herein generally refers to an instruction that may be interpreted to include one or more tasks related to searching for particular information. Some orders may include information requests or queries and vice versa. In particular embodiments, the results returned by information requests or queries may be used for autonomous or semi-autonomous command and control decision support in the context of cyber warfare.

A network 102 includes any suitable hardware, software, firmware, or combination thereof capable of at least partially enabling communications within a cyber domain. In particular embodiments, networks 102 may include, for example, any suitable combination of wireless or wireline communication paths, routers, servers, computers, switches, antennas, satellite networks, public switched telephone networks (PSTN), integrated services digital networks (ISDN), local area networks (LAN), wide area networks (WAN), metropolitan area networks (MAN), all or a portion of the global computer network known as the Internet, and/or some other combination of hardware, software, or firmware located at one or more locations.

Some networks 102 may be used by the public at large, the government, the military, or a combination thereof. For example, networks 102 may include the cyber-enabled components of power grids, power plants, traffic control systems, airports, factories, refineries, all or a portion of a global navigation satellite system (e.g., the Global Positioning System (GPS)), government agency systems, strategic command and control systems, intelligence-gathering systems, reporting systems, data processing systems, or any combination thereof.

Some other networks 102 that may be in use by various military branches may include the cyber-enabled components of the Joint Automated Deep Operations Coordination System (JADOCS), the Advanced Field Artillery Tactical Data System (AFATDS), a Theater Battle Management Core System (TBMCS), the Command and Control Personal Computer (C2PC), FalconView™, the International Security Assistance Force (ISAF), and/or the Global Information Grid (GIG).

As illustrated in FIG. 1, system 100 may include multiple networks 102 that may or may not be communicatively coupled together. Although the illustrated embodiment includes four networks 102a, 102b, 102c, and 102d, system 100 may include any suitable number of networks 102, and networks 102a, 102b, 102c, and/or 102d may each refer to sub-networks of the same common network 102. In this example, network 102a represents a potential target that may be attacked and/or defended at least partially through cyber warfare. In some embodiments, networks 102 may be configured such that the functionality and/or security of networks 102b, 102c, and 102d may be minimally affected or not affected at all if and when cyber warfare is conducted within network 102a.

Monitors 104 generally refer to any hardware, software, firmware, or any combination thereof capable of monitoring any of a variety of parameters of network 102 and providing data accordingly. For example, the monitored parameters may describe any combination of hardware, software, firmware, data transmissions, and/or events associated with network 102. Monitors 104 may provide data to system 100 by communicating with adaptor 106, data storage 108, server 110, any combination thereof, or some other component of system 100. System 100 may use data provided by monitors 104 to enable situational awareness, as explained further below.

Various monitors 104 may collect, store, and/or communicate data related to one or more monitored parameters of network 102 using any of a variety of different formats, standards, syntax, communication protocols, etc. For example, various monitors 104 may provide information and notification using standards substantially similar to the Common Information Model (CIM), the Distributed Management Task Force (DMTF), Simple Network Management Protocol (SNMP), Border Gateway Protocol (BGP), NetFlow developed by Cisco Systems, SYSLOG, any of a variety of other standards that may be used to monitor alarms, security, performance, events, etc. of a cyber domain, any combination of the preceding, or some other standard. Some monitors 104 may include hardware and/or software substantially similar in structure and function to SMARTS technology by EMC²®, NarusInsight™ technology by Narus, Inc., ArcSight technology, HP OpenView technology by Hewlett-Packard Development Company, L.P., IBM Tivoli technology by International Business Machines Corp., intrusion prevention technology (IDS), intrusion prevention technology (IPS), vulnerability scanners, insider threat scanners, Firewalls, anomaly detection technology, antivirus configuration management, and/or any of a variety of other technologies, including future technologies.

Adaptor 106 may include hardware, software, firmware, or combination thereof capable of adapting data provided by monitors 104 according to a cyberBML standard or schema used by system 100. In this example, adaptor 106 is capable of receiving data provided by monitor 104 in any of a variety of proprietary formats or standards, determining which portions of the received data are applicable in a cyber warfare context, and modifying at least a portion of the applicable data according to the cyberBML standard used by system 100. The data adaptation performed by adaptor 106 may include mapping functions, as explained further below. Various adaptors 106 may be capable of increasing the efficiency of the data processing of system 100 in a cyber war context by filtering out inapplicable data. In addition, some adaptors 106 may enable additional options for the types of monitors 104 that system 100 may readily use.

Data storage 108 refers to one or more databases, directories, computer components, devices, volatile or non-volatile memory, and/or recording media capable of retaining computer-readable data and/or facilitating the retrieval of such data. In this example, data storage 108 stores information pertaining to network 102a. For example, data storage 108 may store information describing operational schemas, configurations, performance, security, topology, etc. of network 102a, which system 100 may use to derive situational awareness. At least some of the data stored in data storage 108 may have been generated by monitors 104. The data received and stored at data storage 108 may or may not have been previously modified, mapped, filtered, etc. by adaptor 106.

In a particular embodiment, data storage 108 may include one or more CIM repositories capable of storing network operational CIM data. The CIM data may represent any of a variety of parameters related to network 102. For example, the data may be related to the equipment and/or facilities of network 102a that may be affected by particular action tasks and/or events.

In some embodiments, data storage 108 may include one or more relational databases (e.g., Oracle databases) capable of storing information formatted according to any of a variety of command and control schemas. In a particular embodiment, at least some of the data may be formatted according to the Joint Consultation, Command and Control Information Exchange Data Model (JC3IEDM). JC3IEDM enables conventional non-cyber command and control information, such as, for example, information related to the command and control of maritime, ground, and/or air warfare. In some embodiments, data storage 108 may be populated with real-time data pertaining to conventional command and control information. Particular embodiments may use this real-time data, for example, to facilitate the integration and interoperability of conventional non-cyber command and control with cyber-based command and control.

Server 110 may include any hardware, software, firmware, or combination thereof capable of enabling the communication of information to and/or from clients 112 and/or another component of system 100. In various embodiments, server 110 may include, for example, one or more directory servers, client servers, file servers, domain name servers, proxy servers, web servers, application servers, computer workstations, data repositories, routers, switches, any combination of the preceding, or any other machines or apparatus capable of enabling the communication of information to and/or from client 112 and/or another component of system 100. In the illustrated embodiment, server 110 includes memory 114, interface 116, input/output device 118, and one or more processors 120.

Memory 114 may comprise any suitable volatile or nonvolatile storage and retrieval device or combination of devices. In various embodiments, memory 114 may comprise any combination of storage media including, for example, removable or not readily removable storage media. Additionally, all or part of memory 114 may reside locally within server 110 or could reside remotely from and accessible to server 110.

A cyberBML-enabled application 122, discussed further below, resides at least partially within memory 114 of server 110. The cyberBML-enabled application 122 may comprise software, firmware, data compilations, or a combination thereof.

Clients 112 may each comprise any computing and/or communication device capable enabling the communication of information to and/or from server 110 and/or another component of system 100. In some embodiments, the communication between a particular client 112 and server 110 may be performed internally, such as, for example, via a system bus, and/or the communication between a particular client 112 and server 110 may be through a network. For example, clients 112 may each be capable of communicating one or more requests through network 102d, which requests may be received and processed, for example, by server 110 using cyberBML software embodied in computer-readable media at server 110.

Modifications, additions, or omissions may be made to system 100 without departing from the scope of the disclosure. The components of system 100 may be integrated or separated. For example, the operations of adaptor 106 may be integrated with data storage 108 and/or server 110. Moreover, the operations of system 100 may be performed by more, fewer, or other components. For example, data storage 108 may have any suitable number of storage units. Additionally, operations of system 100 may be performed using any suitable logic comprising software, hardware, and/or other logic. As used in this document, “each” refers to each member of a set or each member of a subset of a set.

In operation, system 100 generally facilitates the command and control of cyber warfare. According to one embodiment, a user issues an order that includes objectives related to the cyber domain of network 102a. The order is expressed in terms of a cyberBML standard or schema and inputted to system 100 via client 112. Client 112 communicates the order to server 110, where it is interpreted by cyberBML-enabled application 122. CyberBML-enabled application 122 uses the interpretation of the order to generate one or more tasks. Some of these tasks may be assigned to automated components for execution within network 102a. Monitors 104 monitor network 102 parameters and provide information to system 100 accordingly. Adaptor 106 adapts this information for use by cyberBML-enabled application 122. CyberBML-enabled application 122 interprets the adapted data and generates situation reports accordingly. System 100 may interpret these situation reports and/or distribute the reports to military users via clients 112 for interpretation. In this manner, system 100 enables situational awareness and operational feedback for both system 100 and military users. Additional detail regarding the operation of system 100 is explained further below with reference to FIG. 2.

FIG. 2 shows one embodiment of a method for facilitating the command and control of cyber warfare that may be performed by the system 100 of FIG. 1. In step 200, the process is initiated.

In step 202, one or more orders, reports, and/or requests are received that may be executed at least partially within a cyber domain. For example, a particular defensive operational order may be used to counteract cyber attacks directed against all or a portion of a friendly network 102, a particular offensive execution order may be used to disable or overtake the control of all or a portion of a particular enemy network 102, and/or a request for information regarding an operation may be received, which may return a situation report that may be used for command and control decision support and situational awareness.

Any suitable human or non-human entity may issue the order, report, and/or request received in step 202. For example, an operational order may be issued by a human user and/or an automated or semi-automated process, agent, or application (e.g., cyberBML-enabled application 122 or some other software application).

According to a particular embodiment, users interface with a graphical user interface (GUI) of clients 112 to input one or more operational orders. The GUI may prompt a user to enter operational orders in a form that may be readily interpreted by or translated into the cyberBML in use by system 100. For example, the GUI may provide fields that a user fills in, the GUI may present constraints and/or restrictions based on received input, the GUI may parse an input provided in sentence form, etc. Client 112 may transmit the inputted operational orders to server 110.

In step 204, the orders, reports, and/or requests received in step 202 are interpreted. At least a portion of the interpretation may be implemented by cyber-BML enabled application 122, when executed by one or more processors 120 located at server 110. In some embodiments, the orders, reports, and/or requests may be interpreted in terms of who, what, when, where, and why in the context of cyber warfare: who should perform tasks derived from the order, report, and/or request (the taskee); who issued the order, report, and/or request (the tasker); who or what to attack or defend (the target); what particular tasks, when executed, would carry out the order, report, and/or request; when or under what circumstances should the order, report, and/or request be executed; what events may trigger an execution of the order, report, and/or request; where within a cyber domain should tasks derived from the order, report, and/or request be executed; why was the order, report, and/or request issued, etc.

According to one embodiment, cyberBML-enabled application 122 automatically interprets one or more verbs from the syntax of an order. These verbs may be interpreted in step 204 to answer the question of what cyber-based tasks are intended by the order. In various embodiments, some cyber-based verbs may include one or more of the following: enabling, disabling, evading, alerting, cyber-attacking, shutting down, opening a route, closing a route, blocking a route, rerouting, or any of a variety of other cyber-based verbs related to tasks that may be executed at least partially within a cyber domain.

Some orders, reports, and/or requests may be interpreted in step 204 to include cyber-based verbs that are syntactically-related to particular entities. For example, some orders may be interpreted to include tasks involving launching or countering a bot attack or virus, planting or removing a digital agent that may be capable of exfiltrating data from network 102, querying particular types of information, or any of a variety of other cyber-based verbs that may be syntactically-related to particular entities.

Orders, reports, and/or requests may also be interpreted in step 204 to describe one or more other actions or tasks that may affect or be affected by the particular tasks ordered. For example, some orders, reports, and/or requests may be interpreted to include the instruction to execute only if and when all or a portion of certain other tasks are executed successfully or unsuccessfully.

Some orders, reports, and/or requests may be interpreted in step 204 to define particular actors. For example, some cyber-based tasks may be at least partially defined in terms of tasker and/or taskee restraints. A tasker restraint may refer to the entity commanding the task (e.g., a human commander and/or an automated system). A taskee restraint may refer to the particular combination of software, hardware, and/or firmware assigned to execute the task. Although some orders may or may not refer to a tasker or taskee directly, in some embodiments particular actors may be automatically tasked by cyberBML-enabled application 122 with executing all or a portion of an order based at least partially on the nature of the order.

In a particular embodiment, the order, report, and/or request may be interpreted in step 204 to include a constraint at least partially defining where an operation is to be performed. For example, some network-centric operations may be constrained geospatially, topographically, categorically according to network configurations or components, or according to some other constraint at least partially defining where an operation associated with a cyber-based order is to be performed.

In various embodiments, the order, report, and/or request may be interpreted in step 204 to include a constraint at least partially defining why an operation is to be performed. For example, an order may include terms at least partially implementing a commander's intent. For example, if particular orders may be executed in multiple ways then the particular manner in which the order is managed by system 100 may be directed by cyber-BML enabled application 122 in accordance with an automated interpretation and/or a human-based interpretation of an intent constraint.

In some embodiments, the order, report, and/or request may be interpreted in step 204 to include a constraint at least partially defining how an operation is to be performed. For example, if particular orders may be executed in multiple ways then the particular manner in the order is managed by system 100 may be automatically directed by cyberBML-enabled application 122 in accordance with an automated interpretation of a constraint at least partially defining how the operation is to be performed.

In step 205, at least a portion of the order, report, and/or request may be executed according to the interpretation of the same performed in step 204. For example, the human and/or non-human taskees identified in step 204 may execute all or a portion of the particular tasks identified.

In step 206, multiple parameters of network 102 are monitored by monitors 104. The parameters monitored in step 206 may be related to any combination of hardware, software, firmware, data transmissions, and/or events associated with network 102; however, any of a variety of parameters may be monitored in step 206.

In some embodiments, step 206 may include monitoring component-level parameters regarding one or more hardware, software, and/or firmware components of network 102. For example, monitors 104 may monitor one or more of the following component-level parameters: performance (e.g., in terms of utilization, packet loss, latency, etc.), topology, configuration, composition, identity (e.g., in terms of name, part classification, function, manufacturer, network address, etc.), operational status (e.g., active, inactive, standby, shutting down, starting up, etc.), and/or some other parameter related to any component-related combination of hardware, software, or firmware of network 102. Various monitors 104 may be capable of sensing parameters for multiple network 102 components at a time and/or for network 102 as a whole.

Some other parameters that may be monitored in step 206 may relate to data transmissions. For example, some monitors 104 may be capable of accessing at least some of the data that may be transmitted within network 102, received at network 102, and/or transmitted from network 102. Some monitors 104 may be configured to monitor for particular data transmissions, such as, for example, the communication of particular bytes, words, headers, or data packets, the transmission of information by a particular component, and/or some other particular data transmission.

Still other parameters that may be monitored in step 206 may be related to the occurrence of particular events. For example, particular monitors 104 may be capable of detecting one or more of the following security-related events: a hostile intrusion, deletion or modification of data, vulnerabilities, insider threats, anomaly detections, detection of covert enemy communications within network 102, the progress or change in operational status of a virus or some other software, hardware, and/or firmware inserted into network 102, some other change in any monitored parameter, or any of a variety of other events that may occur within network 102.

In step 208, monitors 104 generate data responsive to the monitored parameters. For example, monitors 104 may each provide system 100 substantially real-time data corresponding to network 102 parameters.

In step 210, data corresponding to the monitored parameters is received at adaptor 106. For example, the data received at adaptor 106 in step 210 may be transmitted from monitors 104 via networks 102a and/or 102b. In some alternative embodiments, the data may be communicated between data storage 108 and adaptor 106 via network 102b or through an internal connection, such as, for example, via a system bus. However, the data corresponding to the monitored parameters may be received at adaptor 106 in step 210 using any suitable combination of wireless or wireline communication paths.

Some of the data received at adaptor 106 in step 210 may or may not be relevant in particular cyber warfare contexts. For example, data provided by a monitor 104 regarding the rotation speed of a cooling fan unit may or may not have significance in some cyber warfare contexts. In addition, data generated by monitors 104 may or may not be readily useable by and/or formatted according to some embodiments of cyberBML.

In step 212, adaptor 106 adapts the received data for cyber warfare use. For example, adaptor 106 may selectively determine which data received in step 210 is relevant in certain cyber war contexts, and adaptor 106 may filter out any unrelated data accordingly. In addition, adaptor 106 may map at least some of the parameters monitored in step 206 to respective parameters used by computer-readable cyberBML. The mapping may be performed in accordance with a format used by the computer-readable cyberBML, which in some cases may differ in one or more aspects from the format of the data provided by monitors 104. In particular embodiments, the data adapted in step 212 may be transmitted to data storage 108, server 110, or some other component of system 100 for subsequent retrieval and/or processing.

The mapping performed in step 212 may be executed using any suitable computer programming language, including future programming languages. For example, at least a portion of the mapping performed in step 212 may be executed by adaptor 106 using M-Language developed by Massachusetts Institute of Technology (MIT) and/or some other substantially similar computer programming language.

According to one embodiment, the mapping performed in step 212 may be explained in the context of mapping particular parameters formatted according to a CIM data model to respective parameters that may be used by data models substantially similar to the JC3IEDM. Although particular cyber-based CIM parameters may or may not have a direct corollary within the JC3IEDM data model, some of these CIM parameters may be mapped by adaptor 106 to analogous structure of the JC3IEDM data model or otherwise assigned to particular structure identified by the JC3IEDM data model.

TABLES I-VIII below each summarize example mappings that may be performed in step 212 according to one embodiment. In this particular example, the mappings are from a CIM data model to a data model substantially similar to the JC3IEDM; however, any suitable mappings using any of a variety of other data models may be used including, for example, future data models.

TABLE I shows high-level mapping of CIM Structure to JC3IEDM that may be performed in step 212 according to one embodiment.

TABLE I

| CIM Structure | JC3IEDM Data Model Structure |
|---|---|
| ComputerSystem | obj_item −> mat |
| (Agent, Source, Target) | (mat_type_cat_code = “EQ”) |
| IDSSecurityIndication (Alert) | act −> act_event |

Table II shows how particular CIM ComputerSystem elements may be mapped in step 212 to respective elements used by data models substantially similar to the JC3IEDM according to one embodiment.

TABLE II

| CIM - Computer System | JC3IEDM Data Model Structure |
|---|---|
| ComputerName | obj_item.obj_item_id |
| Dedicated | obj_item −> obj_type |
| | obj_type −> mat_type |
| | mat_type −> mat_type_cat_code |
| | mat_type_cat_code − > |
| | elctrnc_eqpt_type_cat_code |
| ElementName | obj_item.name_txt |
| EnabledState | IGNORE |
| TimeOfLastStateChange | IGNORE |
| HealthState | obj_item −> obj_type_stat |
| | obj_item_stat −> mat_stat |
| | mat_stat −> |
| | mat_stat_operat_stat_code |

In a particular embodiment, the CIM ComputerSystem structure includes “Dedicated Code” parameters that may be mapped in step 212 in a manner substantially similar to the mapping shown in TABLE III.

TABLE III

| | JC3IEDM Code |
|---|---|
| CIM Dedicated Code | ElctrncEqptTypeSubcatCode |
| FIREWL | “4” = ELECTRONICS COMMUNICATIONS |
| | NETWORK-ROUTER |
| ROUTER | “4” = ELECTRONICS COMMUNICATIONS |
| | NETWORK-ROUTER |
| SERVER | “5” = ELECTRONICS COMMUNICATIONS |
| | NETWORK-DEVICE |
| SWITCH | “16” = ELECTRONICS COMMUNICATIONS |
| | NETWORK-HUB |

The CIM ComputerSystem structure includes several codes that represent various status indicators. In a particular embodiment, the CIM HealthState code may be mapped in step 212 as shown in TABLE IV.

TABLE IV

| | | JC3IEDM CodeMat/Org/Fac- |
|---|---|---|
| CIM | HealthState | StatOperatStatCode |
| 05 | OK | OPS: Operational |
| 10 | Degrading/Warning | SOPS:Substantially Operational |
| 15 | Minor Failure | SOPS:Substantially Operational |
| 20 | Major Failure | MOPS: Marginally Operational |
| 25 | Critical Failure | NOP: Not Operational |
| 30 | Non-recoverable Error | NOP: Not Operational |

The CIM ComputerSystem structure includes three defined sub-structures: Location, Processor, and IPProtocolEndpoint. TABLE V below illustrates one example of how the Location and IPProtocolEndpoint CIM structures may be mapped in step 212 to structures substantially similar to those used in the JC3IEDM model according to one embodiment. In some embodiments, the mapping performed in step 212 may include parsing the CIM PhysicalLocation string to split the Latitude from the Longitude.

TABLE V

| CIM - Computer System | |
|---|---|
| Location | JC3IEDM Structures |
| Address | obj_item −> obj_item_addr |
| | obj_item_addr −> addr |
| | addr.place_name_txt |
| PhysicalLocation | obj_item −> obj_item_loc |
| | obj_item_loc −> loc |
| | loc −> point |
| | point −> abs_point |
| | abs_point −> geo_point |
| | geo_point.lat_coord |
| | geo_point.long_coord |

If ObjItem may have many addresses, a separate Addr may be added into the ObjItemAddr table to be used explicitly for the CIM IPProtocolEndpoint. Particular embodiments may distinguish the mappings by incrementing the ObjItemAddrIx. According to one embodiment, mapping of the CIM IPProtocolEndpoint may be performed in step 212 as shown in TABLE VI.

TABLE VI

| CIM - ComputerSystem | |
|---|---|
| IPProtocolEndpoint | JC3IEDM Structures |
| Name | obj_item −> obj_item_addr |
| | obj_item_addr −> addr |
| | addr.place_name_txt |
| IPv4Address | obj_item −> obj_item_addr |
| | obj_item_addr −> addr |
| | addr −> elctrnc_addr |
| | elctrnc_addr.name_txt |

The CIM Alert structure defines a Network Operations event. According to a particular embodiment, some of the CIM Alert structure parameters may be ignored and other may be mapped in step 212 as shown in TABLE VII.

TABLE VII

| CIM - IDSSecurityIndication | JC3IEDM Structures |
|---|---|
| Status | IGNORE |
| AlertName | act.name_txt |
| Protocol | IGNORE |
| EventType | IGNORE |
| Severity | act −> act_effect |
| | act_effect −> |
| | act_effect_sev_code |
| AgentAddress | IGNORE |
| AgentHostName | obj_item.obj_item_id |
| (ComputerSystem.Name) | |

The CIM Alert structure has a severity code with values from 0-10 that represent the impact that the Alert has had on the target CIM ComputerSystem element. According to a particular embodiment, these ranges of CIM Severity codes may be mapped in step 212 as shown in TABLE VIII.

TABLE VIII

| | |
|---|---|
| Alert | JC3IEDM Code |
| Severity | ActEffectSevCode |

| | | |
|---|---|---|
| 10 >= Severity > 08 | TOTDSR | Total Disruption |
| 08 >= Severity > 03 | SEVDSR | Severe Disruption |
| 03 >= Severity > 01 | MINDSR | Minor Disruption |
| 01 >= Severity >= 00 | NODSRP | No Disruption |

In step 214, the adapted data is received at server 110. For example, the data adapted by adaptor 106 in step 212 may be transmitted from adaptor 106 to server 110 via network 102c. In some alternative embodiments, the adapted data may be communicated between server 110 and data storage 108 via network 102c or through an internal connection, such as, for example, via a system bus. However, the data adapted in step 212 may be received at server 110 in step 214 using any suitable combination of wireless or wireline communication paths.

The data received at server 110 in step 214 may or may not be relevant to particular orders. For example, data regarding a particular component of network 102 may or may not have significance in the context of some cyber-based orders. In some embodiments, this data may be pushed to server for processing regardless of whether or not it is applicable to certain orders. In some other embodiments, however, server 110 may request particular information from adaptor 106 and/or data storage 108, and the requested data may be received at server in step 214. Some requests by server 110 may be in the form of a search for particular information that may be relevant to an order.

In step 216, the adapted data received at server 110 is processed. In a particular embodiment, at least a portion of the processing performed in step 216 may be implemented by cyber-BML enabled application 122, when executed by one or more processors 120 located at server 110.

According to one embodiment, the processing performed in step 216 may include determining if and/or how at least a portion of the data received at server in step 214 is relevant or irrelevant to a particular order received in step 204. For example, data received at server 110 regarding the operational status of a particular hardware, software, and/or firmware component of network 102 may or may not be deemed relevant to an order interpreted to include a task to disable the component.

In step 222, one or more situation reports are generated. In particular embodiments, the situation reports generated in step 222 may be based at least partially on the processing performed in step 216. Some situation reports generated in step 222 may be expressed in terms of a cyberBML that may be readily understood by humans and/or automated systems. Particular situation reports may describe, for example, the progress of a cyber battle, intelligence on enemy tactics and/or use of network 102, or some other information relevant to cyber warfare.

As shown in FIG. 2, in particular embodiments the situation reports generated in step 222 may be provide a feedback loop that may be used to generate new orders. According to one embodiment, cyberBML-enabled application 122 interprets the situation report in step 226 and may generate one or more new order in step 220 in accordance with its interpretation. For example, cyberBML-enabled application 122 may interpret a situation report generated in step 222 as indicating the failure of a task associated with a particular order received in step 204. At least partially in response, system 100 may generate a new order in step 220 that may be interpreted, for example, by looping back to step 204. The newly interpreted order may include a task substantially similar or differing in one or more aspects to the failed task. In particular embodiments, the new order and associated tasks may be generated autonomously (e.g., fully automated by cyberBML-enabled application 122) or semi-autonomously (e.g., based partially human input, human approval, etc.).

These newly generated orders may be received and processed in step 204 in a manner substantially similar to that described above. In some embodiments, system 100 may generate one or more new orders at least partially in response to one or more situation reports generated in step 222.

In step 224, one or more situation reports may be received at one or more clients 112. For example, the situation reports generated in step 222 may be transmitted from server 110 to client 112 via network 102d and/or through an internal connection, such as, for example, via a system bus. In some alternative embodiments, the situation reports may be communicated between data storage 108 and client 112 via one or more networks 102 and/or servers 110. However, the situation reports may be received at clients 112 in step 224 using any suitable combination of wireless or wireline communication paths.

In step 226, a visual representation of the situation reports received in step 224 may be displayed at client 224. The visual representation of the situation reports may include, for example, text presented in cyberBML format, a graphical representation of a cyber-based situation described in the situation reports, a flowchart of interrelated orders and an estimation of their current progress, and/or any of a variety of other visual representations.

Thus, in particular embodiments, system 100 may facilitate the command and control of cyber warfare by performing fully autonomous or semi-autonomous functions. Some of these functions include: collecting raw data related to a variety of network 102 parameters, adapting the raw data according to a cyberBML standard or schema, providing, interpreting, and/or executing orders directed at a cyber domain, and enabling situational awareness in a cyber warfare context.

Modifications, additions, or omissions may be made to the methods presented herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
receiving data regarding a plurality of first parameters of a network; and
mapping each first parameter to a respective second parameter of a computer-readable cyber battle management language, the computer-readable cyber battle management language operable to:
express an operational order in the form of a text-based instruction having a computational grammatical structure, the operational order related to cyber warfare, and the operational order to be executed at least partially within the network; and
express a situation report related to cyber warfare, the situation report expressed in terms of one or more of the respective second parameters, and the situation report describing a change in one or more of the monitored plurality of first parameters.

2. The method of claim 1, further comprising:
receiving the operational order;
interpreting the operational order;
generating a task based at least in part on the interpretation of the operational order; and
executing at least a portion of the task using one or more components of the network.

3. The method of claim 1, wherein the operational order relates to a command to defend against a combative act directed at the network.

4. The method of claim 1, wherein the operational order relates to a command to attack the network by attempting to exploit or change at least a portion of the network.

5. The method of claim 1, where the operational order comprises:
a task to be executed within the network;
a requester identifier identifying a requester of the task;
a component identifier identifying one or more components of the network to execute at least a portion of the task; and
a timing instruction.

6. The method of claim 1, wherein the computer-readable cyber battle management language is further operable to express intent of a commander that issued the operational order.

7. The method of claim 1, wherein the computer-readable cyber battlement management language is further operable to express an operational order to be executed entirely within the network by one or more components of the network.

8. The method of claim 1, wherein the plurality of first parameters of the network comprises one or more of the following:
a component of the network;
an operational status of the component;
a performance metric of the component; and
an operation event of the network.

9. The method of claim 1, wherein mapping each first parameter to the respective second parameter of the computer-readable cyber battle management language comprises mapping each of a plurality of alert severity codes of one of the first plurality of parameters to respective ones of a plurality of effect codes of the respective second parameter, the number of the plurality of alert severity codes greater than the number of the plurality of effect codes.

10. Logic embodied in computer-readable media and operable, when executed by one or more processors, to:
receive data regarding a plurality of first parameters of a network; and
map each first parameter to a respective second parameter of a computer-readable cyber battle management language, the computer-readable cyber battle management language operable to:
express an operational order in the form of a text-based instruction having a computational grammatical structure, the operational order related to cyber warfare, and the operational order to be executed at least partially within the network; and
express a situation report related to cyber warfare, the situation report expressed in terms of one or more of the respective second parameters, and the situation report describing a change in one or more of the monitored plurality of first parameters.

11. The logic of claim 10, wherein the logic is further operable to:
receive the operational order;
interpret the operational order;
generate a task based at least in part on the interpretation of the operational order; and
execute at least a portion of the task using one or more components of the network.

12. The logic of claim 10, wherein the operational order relates to a command to defend against a combative act directed at the network.

13. The logic of claim 10, wherein the operational order relates to a command to attack the network by attempting to exploit or change at least a portion of the network.

14. The logic of claim 10, where the operational order comprises:
a task to be executed within the network;
a requester identifier identifying a requester of the task;
a component identifier identifying one or more components of the network to execute at least a portion of the task; and
a timing instruction.

15. The logic of claim 10, wherein the computer-readable cyber battle management language is further operable to express intent of a commander that issued the operational order.

16. The logic of claim 10, wherein the computer-readable cyber battlement management language is further operable to express an operational order to be executed entirely within the network by one or more components of the network.

17. The logic of claim 10, wherein the plurality of first parameters of the network comprises one or more of the following:
a component of the network;
an operational status of the component;
a performance metric of the component; and
an operation event of the network.

18. The logic of claim 10, wherein mapping each first parameter to the respective second parameter of the computer-readable cyber battle management language comprises mapping each of a plurality of alert severity codes of one of the first plurality of parameters to respective ones of a plurality of effect codes of the respective second parameter, the number of the plurality of alert severity codes greater than the number of the plurality of effect codes.

19. A cyber warfare command and control system comprising:
a plurality of monitors each capable generating data related to a plurality of first parameters of a network;
an adaptor operable to adapt the data according to a computer-readable cyber battle management language, the computer-readable cyber battle management language operable to:
express an operational order in the form of a text-based instruction having a computational grammatical structure, the operational order related to cyber warfare, and the operational order to be executed at least partially within the network; and
express a situation report related to cyber warfare, the situation report expressed in terms of one or more of the respective second parameters, and the situation report describing a change in one or more of the monitored plurality of first parameters; and
a server communicatively coupled to the adaptor, the server operable to:
interpreting the operational order;
generate a task based at least in part on the interpretation of the operational order; and
assign an execution of the task to one or more components of the network.

20. The cyber warfare command and control system of claim 19, wherein the adaptor is operable to adapt the data according to the computer-readable cyber-battle management language by mapping each of the plurality of first parameters of the network to respective ones of a second plurality of parameters, the computer-readable cyber battle management language capable of expressing a situation related to network using the second plurality of parameters.
